(19) United States
(12) Patent Application Publication
(10) Pub. No.: US 2007/0285383 A1
(43) Pub. Date: Dec. 13, 2007

(54) ELECTRO-OPTICAL DEVICE, METHOD FOR DRIVING ELECTRO-OPTICAL DEVICE, AND ELECTRONIC APPARATUS

(75) Inventor: Hideaki IIZUKA, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/689,293

(22) Filed: Mar. 21, 2007

(30) Foreign Application Priority Data
Apr. 12, 2006 (JP) 2006-109464

(51) Int. Cl. G09G 3/36

(52) U.S. Cl. 345/103

(57) ABSTRACT

An electro-optical device includes a substrate; a plurality of pixel electrodes that are disposed in a pixel area on the substrate; a plurality of scanning lines and a plurality of data lines that are disposed on the substrate so as to intersect each other in the pixel area; an image signal line that is disposed on the substrate, an image signal being supplied to the image signal line, the polarity of the image signal being inverted, every horizontal scanning period, between a positive polarity in which the potential of the image signal is higher than a predetermined potential and a negative polarity in which the potential of the image signal is lower than the predetermined potential; a sampling circuit that is disposed on the substrate and that includes a plurality of sampling switches each supplying one of a plurality of sampled image signals to a corresponding one of the data lines in accordance with a corresponding one of a plurality of sampling signals; a data line driving circuit that is disposed on the substrate and that outputs the sampling signals at timings at which the sampled image signals are to be supplied to the corresponding data lines; a plurality of switching elements that are disposed on the substrate so as to be each electrically connected to a corresponding one of the scanning lines and a corresponding one of the data lines and that perform switching control on the sampled image signals to be supplied from the corresponding data lines to the pixel electrodes corresponding thereto; and a scanning line driving circuit that is disposed on the substrate and that supplies to each of the plurality of scanning lines a scanning signal for switching the state of the corresponding switching element from on to off at a timing that is shifted by a predetermined period of time with respect to a timing at which the polarity of the image signal is inverted.

### BACKGROUND

1. Technical Field

The present invention relates to an electro-optical device, such as a liquid crystal device, a method for driving the electro-optical device, and an electronic apparatus, such as a liquid crystal projector, including the electro-optical device.

2. Related Art

In liquid crystal electro-optical devices, display electrodes, such as pixel electrodes, and driving circuits including a data line driving circuit and a scanning line driving circuit for driving the display electrodes are provided on a substrate. As a method for driving such electro-optical devices, an inversion driving method is adopted. In the inversion driving method, in order to prevent burn-in and deterioration of liquid crystal, the polarities of voltages applied to the pixel electrodes are inverted in accordance with a predetermined rule. A 1H inversion driving method in which the polarity of an image signal supplied to a pixel electrode is alternately inverted between positive and negative every horizontal scanning period in accordance with a predetermined potential is used as an inversion driving method by which high-quality image display can be achieved with relatively easy control.

A clock signal and an inverted clock signal whose phase is inverted with respect to the phase of the clock signal are supplied from an external circuit to the data line driving circuit and the scanning line driving circuit. The data line driving circuit and the scanning line driving circuit operate on the basis of the clock signal and the inverted clock signal. It is desirable that the phase of the clock signal is exactly opposite to the phase of the inverted clock signal. Thus, a phase difference correction circuit that performs correction such that the phase of the clock signal is opposite to the phase of the inverted clock signal is also provided on the substrate (see, for example, JP-A-2004-126551).

When such an electro-optical device is driven, an image signal is supplied from an image signal line to each of a plurality of pixel electrodes via a corresponding data line. In particular, when the polarity of the image signal being supplied to the image signal line is inverted, coupling noise may occur in the potential of the corresponding data line due to a potential difference between the potential of the polarity-inverted image signal and the potential of the data line, which is prior to the polarity of the image signal being inverted. Such coupling noise generated in the potential of the data line affects the pixel electrode that is electrically connected to the data line with a pixel switching element therebetween. In addition, since the pixel switching element is turned off at a timing at which a scanning signal from a scanning line falls, the pixel electrode may have a potential that is shifted from a desired potential, which is problematic.

### SUMMARY

An advantage of some aspects of the invention is that it provides an electro-optical device that is capable of reducing a variation in a pixel voltage caused by coupling noise generated when the polarity of an image signal is inverted and that is capable of displaying an image with high accuracy, a method for driving the electro-optical device, and an electronic apparatus including the electro-optical device.

An electro-optical device according to an aspect of the invention includes a substrate; a plurality of pixel electrodes that are disposed in a pixel area on the substrate; a plurality of scanning lines and a plurality of data lines that are disposed on the substrate so as to intersect each other in the pixel area; an image signal line that is disposed on the substrate, an image signal being supplied to the image signal line, the polarity of the image signal being inverted, every horizontal scanning period, between a positive polarity in which the potential of the image signal is higher than a predetermined potential and a negative polarity in which the potential of the image signal is lower than the predetermined potential; a sampling circuit that is disposed on the substrate and that includes a plurality of sampling switches each supplying one of a plurality of sampled image signals to a corresponding one of the data lines in accordance with a corresponding one of a plurality of sampling signals; a data line driving circuit that is disposed on the substrate and that outputs the sampling signals at timings at which the sampled image signals are to be supplied to the corresponding data lines; a plurality of switching elements that are disposed on the substrate so as to be each electrically connected to a corresponding one of the scanning lines and a corresponding one of the data lines and that perform switching control on the sampled image signals to be supplied from the corresponding data lines to the pixel electrodes corresponding thereto; and a scanning line driving circuit that is disposed on the substrate and that supplies to each of the plurality of scanning lines a scanning signal for switching the state of the corresponding switching element from on to off at a timing that is shifted by a predetermined period of time with respect to a timing at which the polarity of the image signal is inverted.

When the electro-optical device operates, an image signal is supplied to each of a plurality of sampling switches. More specifically, the image signal is supplied to an image signal line, and supplied to a sampling circuit including the sampling switches that are electrically connected to individual data lines. In order to achieve image display with high accuracy while suppressing an increase in a driving frequency, an external circuit may convert a serial image signal into N parallel image signals, such as three parallel image signals, six parallel image signals, twelve parallel image signals, twenty-four parallel image signals, or the like, and the N parallel image signals may be supplied to N image signal lines.

At the same time as the supply of the image signal, a data line driving circuit sequentially supplies sampling signals for individual sampling switches. The sampling switches are turned on, and sampled image signals are supplied to the data lines in accordance with sampling signals. Thus, the sampled image signals are supplied to switching elements that are electrically connected to the data lines. Each of the sampling switches is a single-channel or complementary thin-film transistor. The source of each of the sampling switches is electrically connected to the image signal line, and the drain of each of the sampling switches is electrically connected to the corresponding data line. When a sampling signal is supplied to the gate of each of the sampling switches, the sampling switch is turned on.

As described above, the switching element to which the sampled image signal is supplied performs a switching operation for the image signal in accordance with a pulsed scanning signal supplied from the scanning line driving circuit via the corresponding scanning line. Thus, the sampled image signal is supplied to a corresponding pixel electrode via the data line corresponding thereto, and a display element, such as a liquid crystal element corresponding to the pixel electrode, performs image display on the basis of the supplied sampled image signal.

The polarity of the potential of the image signal is inverted every horizontal scanning period with respect to a predetermined potential, such as a common fixed potential or a ground potential. That is, in accordance with an order in which scanning lines are selected, that is, in accordance with an order in which scanning signals are supplied to scanning lines, for example, line inversion driving or region inversion driving in which inversion driving is performed for each partial region is performed. Scanning lines may be selected in a desired order.

In particular, when the polarity of the image signal supplied to the image signal line is inverted, coupling noise whose amount is not negligible is generated in a data line potential due to a potential difference between the image signal line and a data line. In this case, the timing at which the scanning line driving circuit selects another scanning line, instead of the present scanning line that is being currently selected, that is, the timing at which the level of the waveform of the scanning signal being supplied to the present scanning line falls (that is, the timing at which the switching elements that are electrically connected to the present scanning line are turned off) is within the period in which coupling noise is being generated in the data line potential. Thus, the coupling noise generated in the data line potential affects the pixel electrodes that are electrically connected to the present scanning line via the corresponding switching elements. Since the switching elements are turned off, the pixel electrodes have a potential that is shifted with respect to a desired potential. In other words, an adverse influence of the coupling noise generated in the data line potential on the potentials of the pixel electrodes is held in, for example, one frame period (that is, a period in which an image screen is displayed). Thus, blurring or the like or a streak display defect may be generated in image display.

Thus, in the electro-optical device, the timing at which the scanning signal causes the switching element to be switched from on to off (that is, the timing at which the level of the waveform of the scanning signal falls) is shifted by a predetermined period with respect to the timing at which the polarity of the image signal supplied to the image signal line is inverted. That is, the timing at which the switching elements that are electrically connected to the scanning line that is selected before the polarity of the image signal supplied to the image signal line is inverted are switched from on to off is advanced or delayed by a predetermined period with respect to the timing at which the polarity of the image signal supplied to the image signal line is inverted. More specifically, the timing at which the switching elements that are electrically connected to the scanning line that is selected before the polarity of the image signal supplied to the image signal line is inverted are turned off is advanced with respect to the timing at which generation of the above-described coupling noise generated in the data line potential starts or is delayed with respect to the timing at which the influence of the above-described coupling noise generated in the data line potential is eliminated or almost eliminated (that is, the timing at which the data line potential or the pixel potential becomes a desired potential). Thus, the switching elements that are electrically connected to the scanning line that is selected before the image signal supplied to the image signal, line is inverted are switched from on to off in a state in which the data line potential or the potential of the pixel electrodes is at a desired potential (that is, before the coupling noise is generated in the data line potential or after the coupling noise generated in the data line potential is eliminated or almost eliminated, the switching elements are switched from on to off). Thus, the influence of the coupling noise generated in the data line potential on the potential of the pixel electrodes (that is, the pixel voltage) can be reduced or prevented. Accordingly, blurring or the like in image display or generation of a streak image defect can be reduced or prevented, resulting in achieving image display with high quality.

It is preferable that each of the plurality of switching elements is turned off at a fall timing at which the level of the waveform of the scanning signal falls. It is also preferable that the fall timing is advanced with respect to the timing at which the polarity of the image signal is inverted.

Thus, before coupling noise is generated in the data line potential when the polarity of the image signal is inverted, the scanning signal supplied to the scanning line selected before the polarity of the image signal supplied to the image signal line is inverted falls (that is, the switching elements that are electrically connected to the scanning line are switched from on to off). Thus, the influence of the coupling no se generated in the data line potential on the potential of the pixel electrodes can be reduced or prevented.

It is preferable that each of the plurality of switching elements is turned off at a fall timing at which the level of the waveform of the scanning signal falls. It is also preferable that the fall timing is delayed with respect to the timing at which the polarity of the image signal is inverted.

Thus, after the coupling noise generated in the data line potential is eliminated or almost eliminated, the scanning signal supplied to the scanning line that is selected before the polarity of the image signal supplied to the image signal line is inverted falls (that is, the switching elements that are electrically connected to the scanning line are switched from on to off). Thus, the influence of the coupling noise generated in the data line potential on the potential of the pixel electrodes can be reduced or prevented.

In the case where the fall timing is advanced with respect to the timing at which the polarity of the image signal is inverted, it is preferable that the electro-optical device further includes an enable signal line that supplies to the scanning line driving circuit an enable signal in which a timing at which the level of the waveform of the enable signal falls is advanced by the predetermined period of time with respect to the timing at which the polarity of the image signal is inverted. In addition, it is preferable that the scanning line driving circuit includes a shift register that sequentially outputs transfer signals from a plurality of stages in accordance with a clock signal having a predetermined cycle and a plurality of logic circuits that perform shaping of pulses of the sequentially output transfer signals using the enable signal.

In this case, each of the plurality of logic circuits outputs, for example, the logical product of a transfer signal output from the shift register and an enable signal supplied from the enable signal line. The scanning line driving circuit outputs, as a scanning signal, the obtained logical product to a corresponding scanning line. Thus, the timing at which the level of the waveform of the scanning signal falls can be defined in accordance with the enable signal in which the timing at which the level of the waveform of the enable signal falls is advanced by a predetermined period with respect to the timing at which the polarity of the image signal supplied to the image signal line is inverted. That is, control is performed using the enable signal such that the timing at which the level of the waveform of the scanning signal falls is advanced by the predetermined period with respect to the timing of the polarity inversion. Thus, the influence of the coupling noise generated in the data line potential on the potential of pixel electrodes can be reduced or prevented.

In the case where the fall timing is delayed with respect to the timing at which the polarity of the image signal inverted, it is preferable that the electro-optical device further includes a clock signal line to which a clock signal having a predetermined cycle that defines the fall timing is supplied; and a resistor that is electrically connected between the clock signal line and the scanning line driving circuit.

In this case, when the clock signal passes through the resistor, the signal waveform of the clock signal is not sharp. Thus, the timing at which the clock signal falls can be delayed. Thus, control is performed using the clock signal whose fall timing is delayed such that the timing at which the scanning signal falls is delayed by a predetermined period of time with respect to the timing at which the polarity of the image signal supplied to the image signal line is inverted. Accordingly, the influence of the coupling noise generated in the data line potential on the potential of pixel electrodes can be reduced or prevented.

A method according to an aspect of the invention for driving an electro-optical device including a substrate; a plurality of pixel electrodes that are disposed in a pixel area on the substrate; a plurality of scanning lines and a plurality of data lines that are disposed on the substrate so as to intersect each other in the pixel area; an image signal line that is disposed on the substrate, an image signal being supplied to the image signal line; a sampling circuit that is disposed on the substrate and that includes a plurality of sampling switches each supplying one of a plurality of sampled image signals to a corresponding one of the data lines in accordance with a corresponding one of a plurality of sampling signals; a data line driving circuit that is disposed on the substrate and that outputs the sampling signals to the corresponding data lines; a plurality of switching elements that are disposed on the substrate so as to be each electrically connected to a corresponding one of the scanning lines and a corresponding one of the data lines and that perform switching control on the sampled image signals to be supplied from the corresponding data lines to the pixel electrodes corresponding thereto; and a scanning line driving circuit that is disposed on the substrate and that outputs a scanning signal to each of the plurality of scanning lines includes supplying the image signal to the image signal line such that the polarity of the image signal is inverted, every horizontal scanning period, between a positive polarity in which the potential of the image signal is higher than a predetermined potential and a negative polarity in which the potential of the image signal is lower than the predetermined potential; and supplying the scanning signal to each of the plurality of switching elements via the corresponding scanning line such that the switching element is turned on at a timing at which the corresponding sampled image signal is to be supplied to the corresponding pixel electrode and such that the switching element in the on-state is turned off at a timing that is shifted by a predetermined period of time with respect to a timing at which the polarity of the image signal is inverted.

Thus, similarly to the above-described electro-optical device according to the aspect of the invention, the influence of the coupling noise that may be generated in the data line potential when the polarity of the image signal supplied to the image signal line is inverted on the potential of the pixel electrodes (that is, the pixel voltage) can be reduced or prevented. Accordingly, blurring or the like in image display or generation of a streak display defect can be reduced or prevented, resulting in achieving image display with high accuracy.

Further operations and advantages of the invention will become more apparent from the following descriptions of exemplary embodiments.

### BRIEF DESCRIPTION OF THE DRAWINGS

The invention will be described with reference to the accompanying drawings, wherein like numbers reference like elements.

FIG. 1 is a plan view showing the entire configuration of a liquid crystal panel according to a first embodiment.

FIG. 2 is a cross-sectional view taken along line II-II of FIG. 1.

FIG. 3 is a block diagram showing the entire configuration of a liquid crystal device according to the first embodiment.

FIG. 4 is a block diagram showing an electrical configuration of the liquid crystal panel according to the first embodiment.

FIG. 5A is a circuit diagram showing a configuration of a phase difference correction circuit used in the first embodiment.

FIG. 5B shows signal waveforms at positions of the phase difference correction circuit shown in FIG. 5A.

FIG. 6 is a timing chart for explaining a method for driving the liquid crystal device according to the first embodiment.

FIG. 7 is an illustration for explaining the method for driving the liquid crystal device according to the first embodiment.

FIG. 8 is a timing chart showing a variation In a pixel potential caused by coupling noise generated in a data line potential according to a comparative example.

FIG. 9 is a circuit diagram showing a circuit configuration from an input unit for a Y clock signal and an inverted Y clock signal to a scanning line driving circuit in the first embodiment.

FIG. 10 shows falling of the level of the waveform of the Y clock signal at positions of the phase difference correction circuit shown in FIG. 9.

FIG. 11 is a timing chart showing a timing at which the level of the waveform of a scanning signal falls in the first embodiment.

FIG. 12 is a circuit diagram showing the circuit configuration of a scanning line driving circuit according to a second embodiment.

FIG. 13 is a timing chart for explaining a method for driving the liquid crystal device according to the second embodiment.

FIG. 14 is a timing chart showing a timing at which the level of the waveform of a scanning signal falls in the second embodiment.

FIG. 15 is a plan view showing the configuration of a projector, which is an example of an electronic apparatus including an electro-optical device.

### DESCRIPTION OF EXEMPLARY EMBODIMENTS

Embodiments of the invention will be described with reference to the drawings. In the following descriptions, a thin-film transistor (TFT) active-matrix-driven liquid crystal device provided with built-in driving circuits, which is an example of an electro-optical device according to an embodiment of the invention, will be described as an example.

### First Embodiment

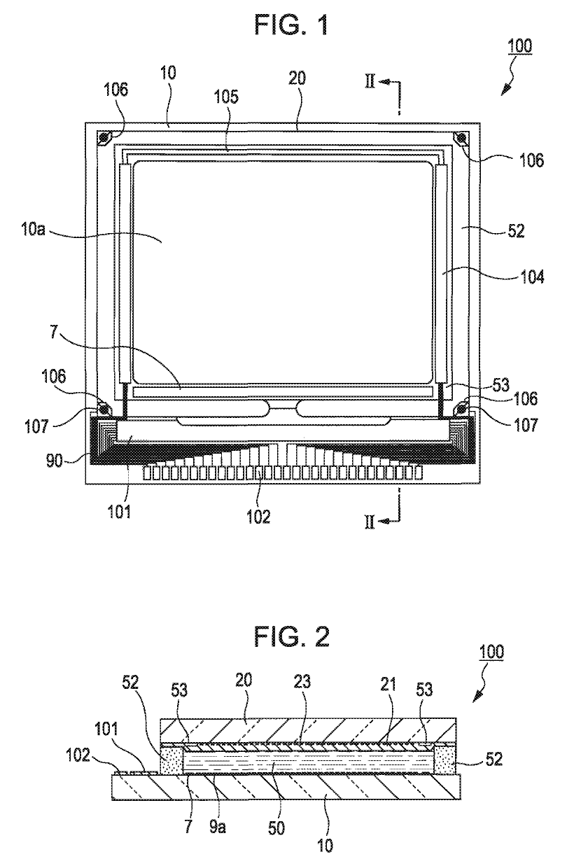

A liquid crystal device according to a first embodiment of the invention will be described with reference to FIGS. 1 to 11.

The entire configuration of a liquid crystal panel, which is an example of an electro-optical panel, in the liquid crystal device according to the first embodiment is described with reference to FIGS. 1 and 2. FIG. 1 is a plan view showing a configuration of the liquid crystal panel according to the first embodiment, and FIG. 2 is a cross-sectional view taken along line II-II of FIG. 1.

Referring to FIGS. 1 and 2, a liquid crystal panel 100 according to the first embodiment includes a TFT array substrate 10 and a counter substrate 20 that face each other. A liquid crystal layer 50 is filled in a space between the TFT array substrate 10 and the counter substrate 20. The TFT array substrate 10 and the counter substrate 20 are bonded together with a sealing material 52 provided in a sealing area disposed around an image display area 10a.

Referring to FIG. 1, on the counter substrate 20, a frame-like light-shielding film 53 that defines the periphery of the image display area 10a is disposed further inward than and in parallel to the sealing area in which the sealing material 52 is disposed. In a portion of a peripheral region that is outside the sealing area in which the sealing material 52 is disposed, a data line driving circuit 101 and external circuit connection terminals 102 are disposed along a side of the TFT array substrate 10. A sampling circuit 7 is disposed further inward than the sealing area and along the side along which the data line driving circuit 101 and the external circuit connection terminals 102 are disposed. The sampling circuit 7 is covered with the frame-like light-shielding film 53. Scanning a line driving circuits 104 are disposed further inward than the sealing area and along two sides adjacent to the side along which the data line driving circuit 101 and the external circuit connection terminals 102 are disposed. The scanning line driving circuits 104 are covered with the frame-like light-shielding film 53. In addition, in order to connect the two scanning line driving circuits 104, which are disposed on both sides the image display area 10a, a plurality of wiring patterns 105 are disposed along the remaining side of the TFT array substrate 10. The wiring patterns 105 are covered with the frame light-shielding film 53. Upper and lower conductive terminals 106 for connecting the TFT array substrate 10 and the counter substrate 20 using upper and lower conductive materials 107 are disposed in portions of the counter substrate 10 that face four corner portions of the counter substrate 20. Thus, electrical conduction between the TFT array substrate 10 and the counter substrate 20 can be achieved.

Routing wiring patterns 90 that are provided for electrically connecting the external circuit connection terminals 102 to the data line driving circuit 101, the scanning line driving circuits 104, the vertical conduction terminals 106, and the like are disposed on the TFT array substrate 10.

Referring to FIG. 2, a laminated structure in which pixel switching TFTs, lines such as scanning lines and data lines, and the like are incorporated is formed on the TFT array substrate 10. In the image display area 10a, pixel electrodes 9a are disposed on a layer upper than the pixel switching TFTs, lines such as the scanning lines and the data lines, and the like. A light-shielding film 23 is formed on the surface of the counter substrate 20 that faces the TFT array substrate 10. Counter electrodes 21, which are formed of a transparent material, such as indium tin oxide (ITO), are formed on the light-shielding film 23 such that the counter electrodes 21 face the pixel electrodes 9a. The liquid crystal layer 50 is formed of one type of nematic liquid crystal or a mixture of a plurality of types of nematic liquid crystal. A predetermined alignment condition is achieved between a pair of alignment films.

Although not illustrated, a resistor for delaying the timing at which the level of the waveform of a Y clock signal falls, a phase difference correction circuit, and the like are formed, as well as the data line driving circuit 101 and the scanning line driving circuits 104, on the TFT array substrate 10. In addition to the above-mentioned component parts, an inspection circuit, an inspection pattern, and the like for checking the quality or checking for a defect of the liquid crystal device in the process of production and before shipment may be formed.

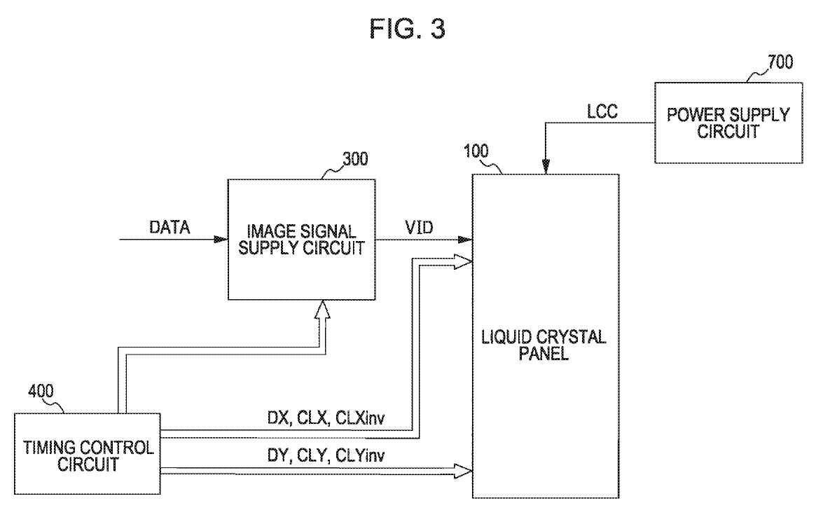

The entire configuration of the liquid crystal device according to the first embodiment will be described next with reference to FIG. 3. FIG. 3 is a block diagram showing the entire configuration of the liquid crystal device.

Referring to FIG. 3, the liquid crystal device includes the liquid crystal panel 100. The liquid crystal device also includes an image signal supply circuit 300, a timing control circuit 400, and a power supply circuit 700, which are provided as external circuits.

The timing control circuit 400 is configured to output various timing signals to be used in various component parts. A timing signal output unit, which is part of the timing control circuit 400, generates a dot clock, which is a clock represented by the smallest unit and which is used for scanning an individual pixel. In accordance with the dot clock, a Y clock signal CLY, an inverted Y clock signal CLYinv, an X clock signal CLX, an inverted X clock signal CLXinv, a Y start pulse DY, and an X start pulse DX are generated.

A piece of input image data DATA is input from the outside to the image signal supply circuit 300. The image signal supply circuit 300 generates an image signal VID by performing conversion on the input image data DATA such that the potential of the image signal VID is alternately inverted between positive and negative every horizontal scanning period in accordance with a predetermined reference potential. The image signal supply circuit 300 may generate n image signals VID1 to VIDn, such as six image signals VID1 to VID6, nine image signals VID1 to VID9, twelve image signals VID1 to VID12, twenty-four image signals VID1 to VID24, forty-eight image signals VID1 to VID48, or ninety-six image signals VID1 to VID96, by performing serial-parallel conversion of a piece of input image data DATA.

The power supply circuit 700 supplies a common power supply of a predetermined common potential LCC to each of the counter electrodes 21, which have been described above with reference to FIG. 2. The counter electrodes 21 are formed on the counter substrate 20 such that the counter electrodes 21 face the pixel electrodes 9a.

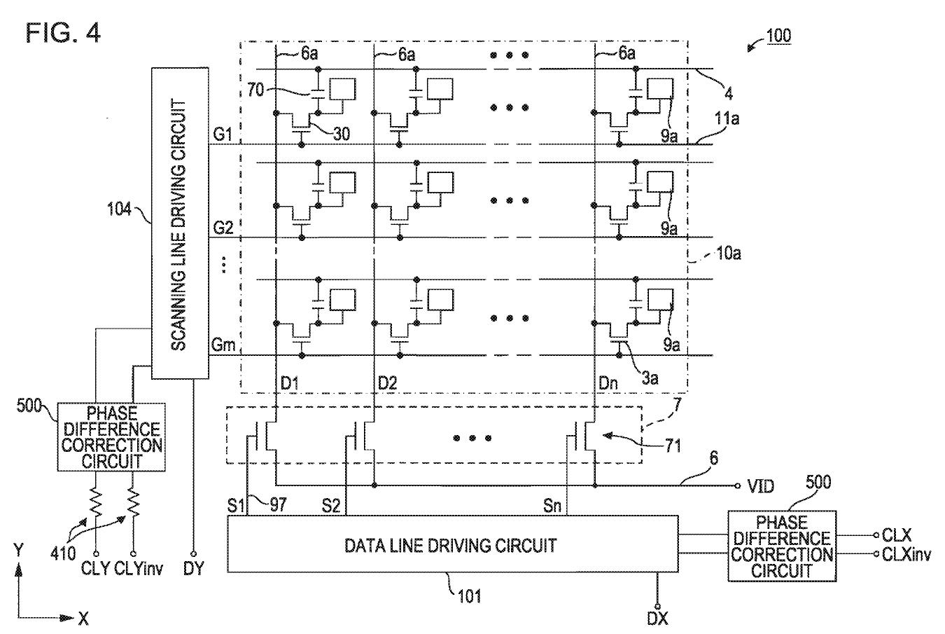

The electrical configuration of the liquid crystal panel 100 will be described with reference to FIG. 4. FIG. 4 is a block diagram showing the electrical configuration of the liquid crystal panel.

Referring to FIG. 4, in the liquid crystal panel 100, internal driving circuits including the scanning line driving circuit 104, the data line driving circuit 101, and the sampling circuit 7 are provided in the peripheral region on the TFT array substrate 10.

The Y clock signal CLY, the inverted Y clock signal CLYinv, and the Y start pulse DY are supplied to the scanning line driving circuit 104. When receiving the Y start pulse DY, the scanning line driving circuit 104 sequentially generates and outputs scanning signals Gi (i=1, 2, . . . , and m) in accordance with timings based on the Y clock signal CLY and the inverted Y clock signal CLYinv.

The X clock signal CLX, the inverted X clock signal CLXinv, and the X start pulse DX are supplied to the data line driving circuit 101. When receiving the X start pulse DX, the data line driving circuit 101 sequentially generates and outputs sampling signals Si (i=1, 2, . . . , and n) in accordance with timings based on the X clock signal CLX and the inverted X clock signal CLXinv.

The sampling circuit 7 includes a plurality of sampling switches 71 provided for individual data lines 6a. An image signal VID is supplied to each of the individual sampling switches 71, and the sampling switches 71 are sequentially turned on in accordance with sampling signals Si output from the data line driving circuit 101. That is, the image signal VID is sampled for each of the data lines 6a in accordance with a corresponding sampling signal Si, and data signals Di (i=1, . . . , and n) are applied to the individual data lines 6a.

More specifically, each of the sampling switches 71 is, for example, a single-channel TFT, such as a P-channel TFT or an N-channel TFT, or a complementary TFT. An image signal line 6 is connected to the source electrode of each of the sampling switches 71, and sampling signal lines 97 are connected to the gate electrodes of the sampling switches 71. When receiving an image signal VID via the image signal line 6 and sampling signals Si from the data line driving circuit 101 via the corresponding sampling signal lines 97, the sampling switches 71 sample the image signal VID and apply data signals Di to the corresponding data lines 6a.

As shown in FIG. 4, a plurality of pixels are formed in a matrix in the image display area 10a of the TFT array substrate 10. Each of the pixels includes the corresponding pixel electrode 9a and a TFT 30 that performs switching control of the pixel electrode 9a. The data lines 6a that receive data signals Di are electrically connected to the sources of the TFTs 30. The data signals Di to be written to the data lines 6a may be supplied line-sequentially in this order. Alternatively, a plurality of data signals Di may be collectively supplied, in units of groups, to a data line group including a plurality of data lines 6a that are adjacent to each other. The TFTs 30 are examples of a plurality of switching elements used in an embodiment of the invention.

Scanning lines 11a are electrically connected to the gates of the TFTs 30. Scanning signals G1, G2, . . . , and Gm are line-sequentially applied in that order from the scanning line driving circuit 104 to the scanning lines 11a at predetermined timings. For simplicity of description, the scanning signals G1, G2, . . . , and Gm are line-sequentially applied to the scanning lines 11a in that order in the first embodiment. However, the scanning signals Gi (i=1, 2, . . . , and m) may be applied to the scanning lines 11a in a desired order. The pixel electrodes 9a are electrically connected to the drains of the TFTs 30. The data signals Di, which are supplied from the data lines 6a, are written at predetermined timings when the TFTs 30, which are switching elements, are turned on for a predetermined period of time.

The data signals Di (i=1, 2, . . . , and n) at predetermined levels written to liquid crystal via the pixel electrodes 9a are held between the pixel electrodes 9a and the counter electrodes 21 (see FIG. 2) formed on the counter substrate 20 (see FIG. 2) for a predetermined period of time. Since the alignment and order of liquid crystal molecules changes in accordance with the level of an applied voltage, liquid crystal modulates light and thus achieves grayscale display. In a normally white mode, the transmission factor with respect to incident light decreases in accordance with an applied voltage for each pixel. In a normally black mode, the transmission factor with respect to incident light increases in accordance with an applied voltage for each pixel. As a whole, light having a contrast level in accordance with an image signal is emitted from the liquid crystal device.

In order to avoid leakage of an image signal held in liquid crystal, storage capacitors 70 are provided in parallel to the liquid crystal capacitors formed between the pixel electrodes 9a and the counter electrodes 21. First electrodes of the storage capacitors 70 are connected, in parallel to the pixel electrodes 9a, to the drains of the TFTs 30. Second electrodes of the storage capacitors 70 are connected to capacitor lines 4 having a constant potential so that the second electrodes have a constant potential.

In addition, as shown in FIG. 4, in the peripheral region on the TFT array substrate 10 of the liquid crystal panel 100, a phase difference correction circuit 500 is provided between the data line driving circuit 101 and an input unit that receives an X clock signal CLX and an inverted X clock signal CLXinv. The phases of the X clock signal CLX and the inverted X clock signal CLXinv, which are supplied from the timing control circuit 400 (see FIG. 3), are adjusted in the phase difference correction circuit 500, and then supplied to the data line driving circuit 101.

Another phase difference correction circuit 500 is provided between the scanning line driving circuit 104 and an input unit that receives a Y clock signal CLY and an inverted Y clock signal CLYinv. The phases of the Y clock signal CLY and the inverted Y clock signal CLYinv, which are supplied from the timing control circuit 400 (see FIG. 3), are adjusted in the phase difference correction circuit 500, and then supplied to the scanning line driving circuit 104.

Accordingly, an operation for writing an image signal VID to each of the pixels can be performed without causing false operations of the data line driving circuit 101 and the scanning line driving circuit 104.

In the first embodiment, in particular, resistors 410 are provided between the phase difference correction circuit 500 and an input terminal of the input unit that receives the Y clock signal CLY and between the phase difference correction circuit 500 and an input terminal of the inverted Y clock signal CLYinv. As described below, the resistors 410 allow timings at which the Y clock signal CLY and the inverted Y clock signal CLYinv fall to be delayed.

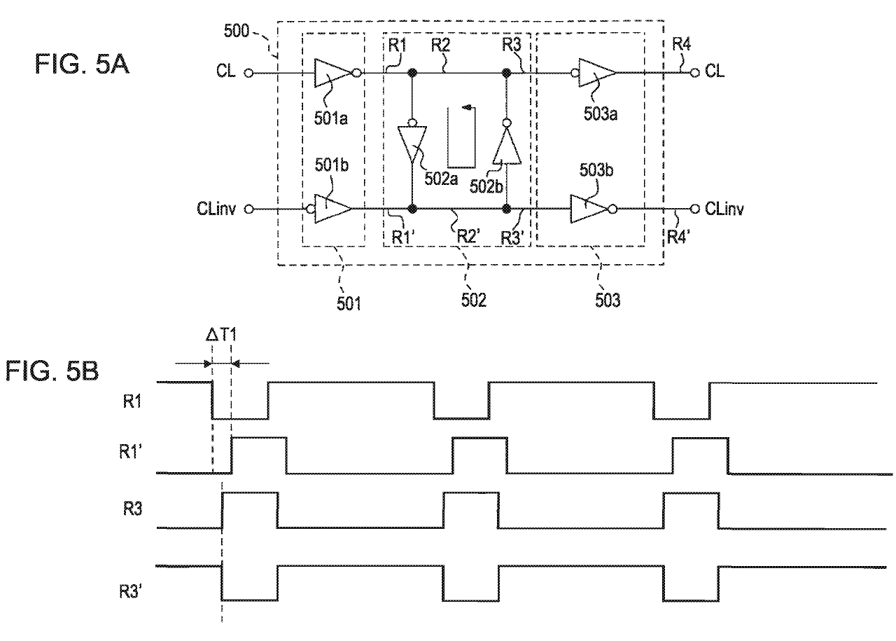

A configuration and operation of the phase difference correction circuit 500 used in the first embodiment will now be described with reference to FIGS. 5A and 5B. FIG. 5A is a circuit diagram showing the configuration of the phase difference correction circuit 500. FIG. 5B shows signal waveforms at positions of the phase difference correction circuit 500 shown in FIG. 5A.

As shown in FIG. 5A, the phase difference correction circuit 500 includes a first buffer circuit 501, a bistable circuit 502, and a second buffer circuit 503. The first buffer circuit 501 includes inverters 501a and 501b. The bistable circuit 502 includes inverters 502a and 502b. The second buffer circuit 503 includes inverters 503a and 503b.

As shown in FIG. 5B, even if a phase difference of a period ΔT1 is generated between a clock signal CL and an inverted clock signal CLinv at positions R1 and R1′, since the bistable circuit 502 corrects the phase difference, there is no phase difference at positions R3 and R3′ at which the bistable circuit 502 outputs the processed clock signal and the processed inverted clock signal.

Referring to FIG. 5A, in the phase difference correction circuit 500, the first buffer circuit 501, which includes the inverters 501a and 501b, complements the driving capability of a circuit that supplies the clock signal CL and the inverted clock signal CLinv. In addition, in the bistable circuit 502, an output of the inverter 502a is supplied to an input terminal of the inverter 502b, and an output of the inverter 502b is supplied to an input terminal of the inverter 502a. Thus, input signals of the inverters 502a and 502b are subjected to positive feedback so that the phase difference is canceled out.

In the phase difference correction circuit 500, the second buffer circuit 503 is disposed downstream the bistable circuit 502. An operation of the second buffer circuit 503 prevents the driving capability of the bistable circuit 502 from being deteriorated.

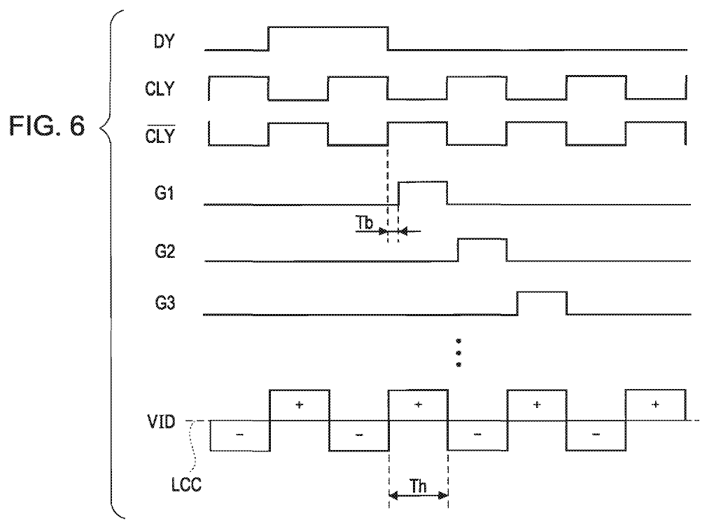

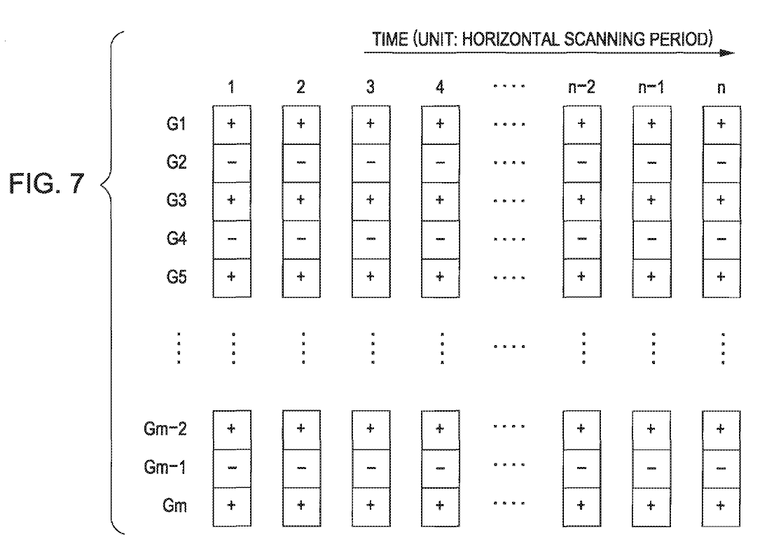

A method for driving the liquid crystal device according to the first embodiment will be described with reference to FIGS. 6 to 11. FIG. 6 is a timing chart showing timings at which scanning signals are supplied. FIG. 7 shows changes of polarities of pixel electrodes on a screen.

Referring to FIG. 6, the scanning line driving circuit 104 applies scanning signals Gi (i=1, 2, . . . , and n), which are generated in accordance with a Y clock signal CLY, an inverted Y clock signal CLYinv, and a Y start pulse DY serving as reference clocks used for application of the scanning signals, to the scanning lines 11a. More specifically, when receiving the start pulse DY, which defines a vertical scanning period, the scanning line driving circuit 104 supplies a scanning signal Gi to a scanning line 11 every horizontal scanning period Th, which is defined by the Y clock signal CLY. That is, the scanning line driving circuit 104 sequentially selects individual scanning lines 11. A data signal Di is written to each of the pixel electrodes 9a corresponding to intersections of the scanning line 11a selected for every horizontal scanning period Th and m data lines. In contrast, the polarity of an image signal VID supplied to the image signal line 6 is inverted every horizontal scanning period Th. Thus, 1 H inversion driving (or line inversion driving) in which the polarity of the potentials of the pixel electrodes 9a is opposite between two adjacent scanning lines is performed. The scanning signals Gi may be supplied to the m scanning lines 11a in a desired order. At the beginning of each of the horizontal scanning period Th, a horizontal flyback period Tb that is not contributed to display is provided.

That is, as shown in FIG. 7, when attention is paid to each horizontal scanning period, for example, data signals having positive potentials are written to the pixel electrodes 9a scanned in accordance with the scanning signals G1, G3, G5, . . . , and G2k+1, and data signals having negative potentials are written to the pixel electrodes 9a scanned in accordance with the scanning signals G2, G4, G6, . . . , and G2k. Accordingly, on a screen, a positive potential or a negative potential is alternately written in pixel electrodes 9a in each scanning line 11a.

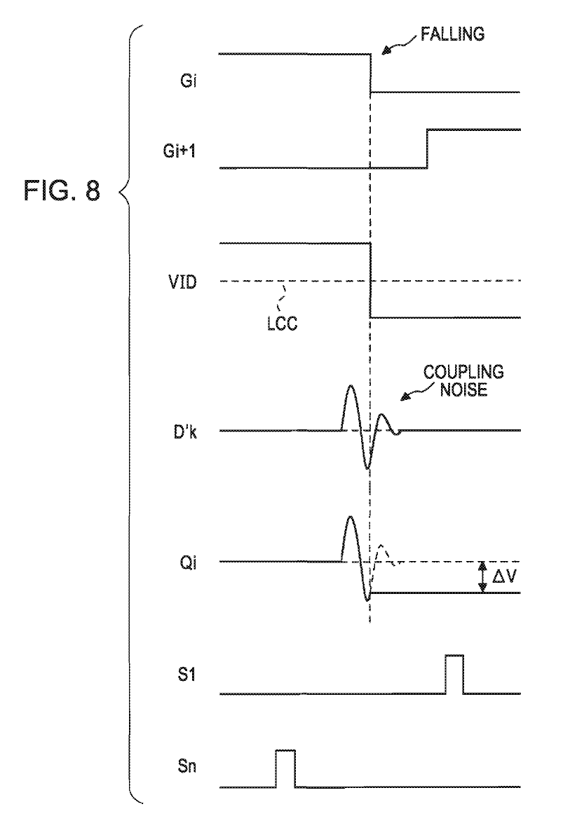

FIG. 8 is a timing chart showing a variation of a pixel potential caused by coupling noise generated in a data line potential according to a comparative example.

As shown by the comparative example of FIG. 8, if no countermeasures are taken, an adverse influence caused by coupling noise generated in a potential D′k of a data line 6a (that is, the data line potential D′k) that may be generated by the above-mentioned 1 H inversion driving may be held as a potential Qi of a pixel electrode 9a (that is, the pixel potential Qi). The data line potential D′k means the potential of the data line 6a to which a data signal Dk is supplied. During the period in which the corresponding sampling switch 71 is turned off, the data line potential D′k is normally the same as the potential of the data signal Dk. The pixel potential Qi means the potential of the pixel electrode 9a that is electrically connected to the scanning line to which a scanning signal Gi is supplied and electrically connected to the data line 6a to which the data signal Dk is supplied.

That is, in FIGS. 4 and 8, in the above-mentioned 1H inversion driving, when the polarity of an image signal VID supplied to the image signal line 6 is inverted, coupling noise whose amount is not negligible is generated in the data line potential D′k due to a potential difference between the image signal line 6 and a data line 6a (that is, the potential difference between the potential of the image signal VID and the data line potential D′k). More specifically, for example, in the first horizontal scanning period, after a data signal Di based on the image signal VID having a positive polarity is written to each of the pixel electrodes 9a corresponding to a scanning line 11a and n data lines 6a, all the n sampling switches that are electrically connected to the n data lines 6a are in the off-state, and the data line potential D′k is the same as the potential of the data signal Di. Then, when the second horizontal scanning period starts, the image signal VID having a negative polarity is supplied to the image signal line 6. In this case, since a relatively large potential difference is generated between the data line potential D′k, which has the positive polarity, and the potential of the image signal line 6 (that is, the potential of the image signal VID), which has a negative polarity, coupling noise is generated, via the corresponding sampling switches 71 in the off-state, in the data line potential D′k.

In the first embodiment, the polarity of the potential of the image signal VID is inverted within, for example, a range of ±5 V on the basis of the common potential LCC, which is, for example, 7 V. That is, the image signal VID is changed by the potential difference, which is at most 12 V. Thus, a potential difference of at most 12 V may be generated between the data line potential D′k and the potential of the image signal line 6.

In contrast, when the polarity of an image signal VID supplied to the image signal line 6 is inverted, the timing at which the scanning line driving circuit 104 selects another scanning line 11a, instead of the present scanning line 11a that is being currently selected, that is, the timing at which the level of the waveform of the scanning signal Gi being supplied to the present scanning line 11a falls (that is, the timing at which the at TFTs 30 that are electrically connected to the present scanning line 11a are turned off) is within the period in which coupling noise is being generated in the data line potential D′k. Thus, the coupling noise generated in the data line potential D′k affects the pixel electrodes 9a that are electrically connected to the present scanning line 11a via the corresponding TFTs 30. Since the TFTs 30 are turned off, a potential that is shifted by a potential difference ΔV with respect to a desired potential (that is, the data line potential D′k before coupling noise is generated) is held as a pixel potential Qi. In other words, an adverse influence on the pixel potential Q1 caused by the coupling noise generated in the data line potential D′k is held in, for example, one frame period (that is, a period in which an image screen is displayed). Thus, blurring or the like or a streak display defect may be generated in image display.

In the firs embodiment, in particular, as described above with reference to FIG. 4, the resistors 410 are provided between the phase difference correction circuit 500 and the input terminal to which a Y clock signal CLY is supplied and between the phase difference correction circuit 500 and the input terminal to which an inverted Y clock signal CLYinv is supplied.

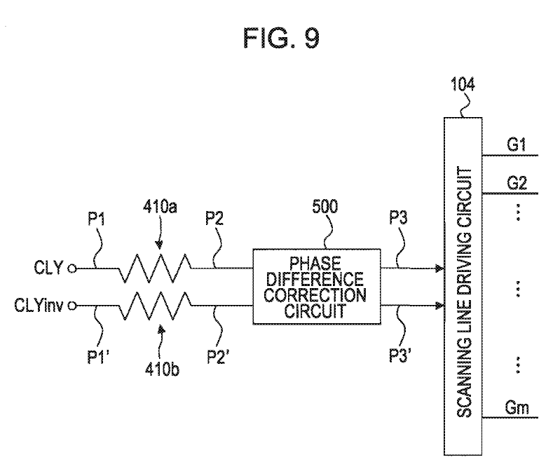

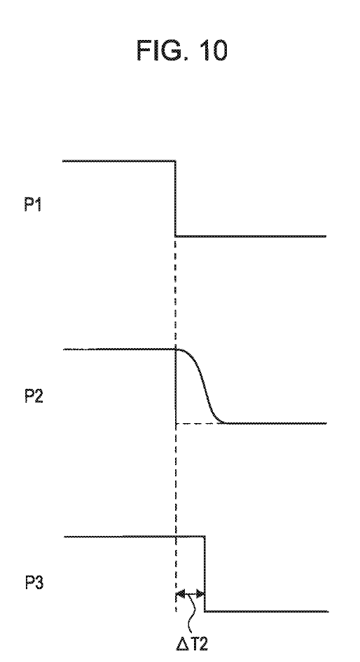

FIG. 9 shows a circuit configuration from the input unit to which the Y clock signal CLY and the inverted Y clock signal CLYinv are input to the scanning line driving circuit 500. FIG. 10 shows falling of the level of the waveform of the Y clock signal CLY at positions of the phase difference correction circuit 500 shown in FIG. 9.

As shown in FIG. 9, a resistor 410a is provided between the input terminal to which the Y clock signal CLY is supplied and the phase difference correction circuit 500, and a resistor 410b is provided between the input terminal to which the inverted Y clock signal CLYinv is supplied and the phase difference correction circuit 500. Thus, the Y clock signal CLY is supplied to the scanning line driving circuit 104 through the resistor 410a and the phase difference correction circuit 500, and the inverted Y clock signal CLYinv is supplied to the scanning line driving circuit 104 through the resistor 410b and the phase difference correction circuit 500.

As shown in FIG. 10, by using the resistor 410a, the level of the waveform of the Y clock signal CLY input from the timing control circuit 400 (see FIG. 3) falls gradually. That is, compared with the falling of the level of the signal waveform of the Y clock signal CLY at position P1, the level of the signal waveform of the Y clock signal CLY at position P2 falls gradually. In other words, since the Y clock signal CLY has already passed through the resistor 410a before reaching position P2, compared with the Y clock signal CLY at position P1, the falling of the Y clock signal CLY is delayed and the falling slope is moderate at position P2.

Similarly, since the inverted Y clock signal CLYinv has already passed through the resistor 410b before reaching position P′2, compared with the inverted Y clock signal CLY at position P′1, the falling of the inverted Y clock signal CLY is delayed and the falling slope is moderate at position P′2.

As described above, the Y clock signal CLY and the inverted Y clock signal CLYinv whose falling is delayed and whose falling slope is moderate due to the use of the resistors 410a and 410b are input to the phase difference correction circuit 500, and the phase difference correction circuit 500 corrects a phase difference. Thus, the Y clock signal CLY at position P3 has a signal waveform whose falling is shifted by a predetermined period ΔT2 with respect to the falling of the Y clock signal CLY at position P1. Similarly, the inverted Y clock signal CLYinv at position P′3 has a signal waveform whose falling is shifted by the predetermined period ΔT2 with respect to the falling of the inverted Y clock signal CLYinv at position P1.

That is, a Y clock signal CLY and an inverted Y clock signal CLYinv in which the timings of falling of the levels of the waveforms thereof are delayed by the predetermined period ΔT2 with respect to the timings of falling of the levels of the waveforms of a Y clock signal CLY and an inverted Y clock signal CLYinv output from the timing control circuit 400 (see FIG. 3) are supplied to the scanning line driving circuit 104. That is, the timing at which the level of the waveform of the Y clock signal CLY (or the inverted Y clock signal CLYinv) to be supplied to the scanning line driving circuit 104 falls is delayed by the predetermined period ΔT2 with respect to the timing at which the polarity of an image signal VID is inverted every horizontal scanning period defined by the Y clock signal CLY and the inverted Y clock signal CLYinv output from the timing control circuit 400 (see FIG. 3). The predetermined period ΔT2 may be set in advance to be long enough for eliminating coupling noise generated in a data line potential, as described later. The predetermined period ΔT2 can be adjusted using the resistances of the resistors 410a and 410b.

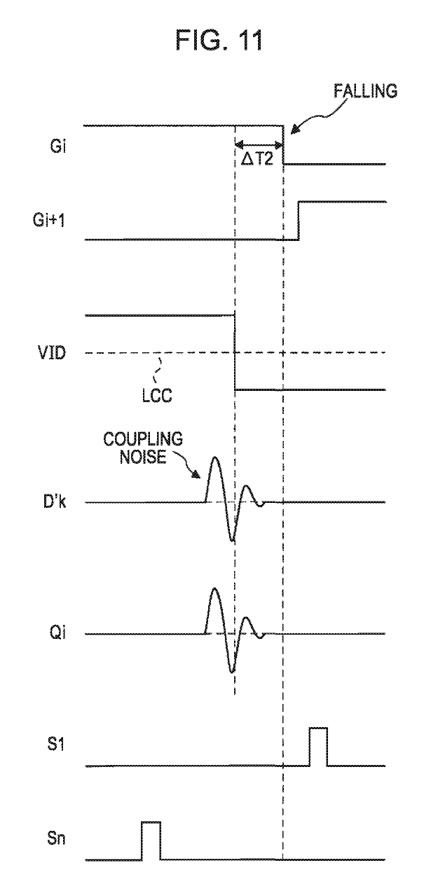

FIG. 11 is a timing chart showing a timing at which a scanning signal falls in the first embodiment.

Referring to FIG. 11, in particular, as described above, the timing at which the waveform of the Y clock signal CLY (or the inverted Y clock signal CLYinv) to be supplied to the scanning line driving circuit 104 is delayed by the predetermined period ΔT2 with respect to the timing at which the polarity of the image signal VID is inverted every horizontal scanning period. Thus, the timing at which the level of the waveform of the scanning signal Gi falls is shifted by the predetermined period ΔT2 with respect to the timing at which the polarity of the image signal VID is inverted. That is, the timing at which the TFTs 30 that are electrically connected to the scanning line 11a to which the scanning signal Gi is supplied before the polarity of the image signal VID is inverted are turned off is shifted by the predetermined period ΔT2 with respect to the timing at which the polarity of the image signal VID is inverted. More specifically, the timing at which the TFTs 30 that are electrically connected to the scanning Line 11a to which the scanning signal Gi is supplied before the polarity of the image signal VID is inverted are turned off is delayed with respect to the timing at which the influence of coupling noise generated in the data line potential D′k is eliminated or almost eliminated (that is, the timing at which the data line potential D′k or the pixel potential Q1, which is the same as data line potential D′k through the TFTs 30, becomes a desired potential). Thus, the TFTs 30 that are electrically connected to the scanning line 11a to which the scanning signal Gi is supplied before the polarity of the image signal VID is inverted are switched from on to off in a state in which the data line potential D′k and the pixel potential Qi are at a desired potential (that is, after the coupling noise generated in the data line potential D′k is eliminated or almost eliminated, the TFTs 30 are switched from on to off). Thus, the influence of the coupling noise generated in the data line potential D′k on the pixel potential Qi (that is, the pixel voltage) can be reduced or prevented. Accordingly, blurring or the like in image display or generation of a streak display defect can be reduced or prevented, resulting in achieving image display with high quality.

In FIG. 11, it is desirable that the predetermined period ΔT2 is set to, for example, 200 to 300 nanoseconds. That is, it is desirable that the resistances of the resistors 410 are set such that the predetermined period ΔT2 is, for example, 200 to 300 nanoseconds. Accordingly, after the coupling noise generated in the data line potential D′k is eliminated or almost eliminated, the TFTs 30 that are electrically connected to the scanning line 11a to which the scanning signal Gi is supplied before the polarity of the image signal VID is inverted can be switched from on to off in a state in which the data line potential D′k and the pixel potential Xi are at a desired potential.

In FIG. 11, the predetermined period ΔT2 can be set within a period of time from the timing at which the polarity of the image signal VID is inverted to the timing at which the next sampling signal S1 is supplied. That is, the data line 6a is not electrically connected to the image signal line 6 until the sampling switch 71 is turned off in accordance with the sampling signal S1. Thus, after the predetermined period ΔT2 passes, the data line potential D′k and the pixel potential Qi are able to be at a desired potential without being influenced by coupling noise.

### Second Embodiment

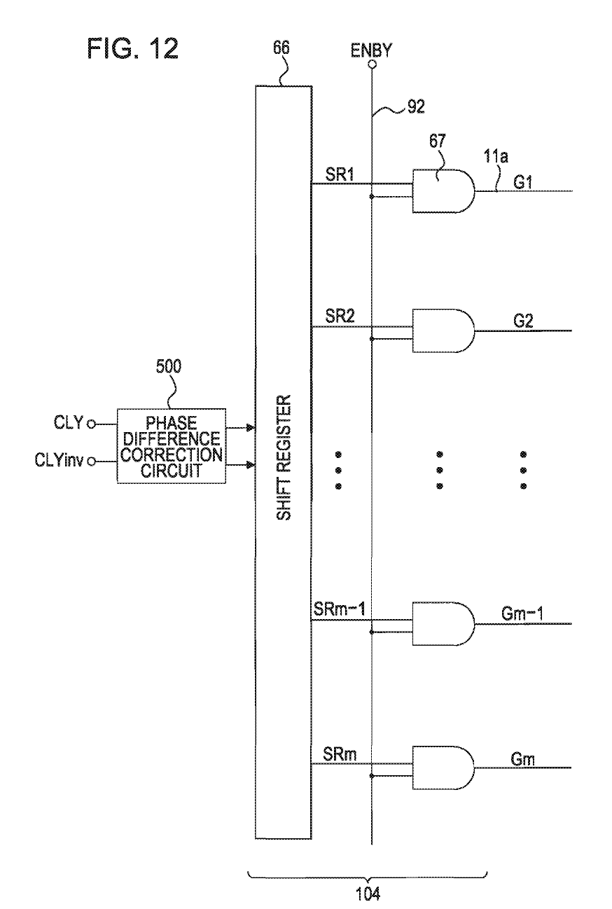

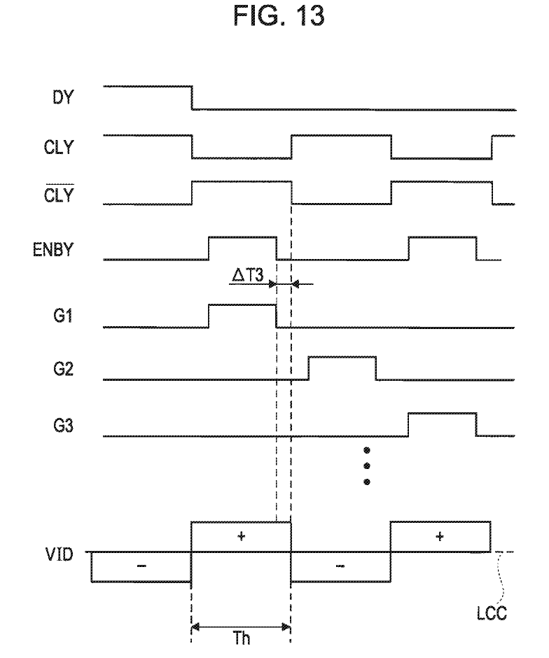

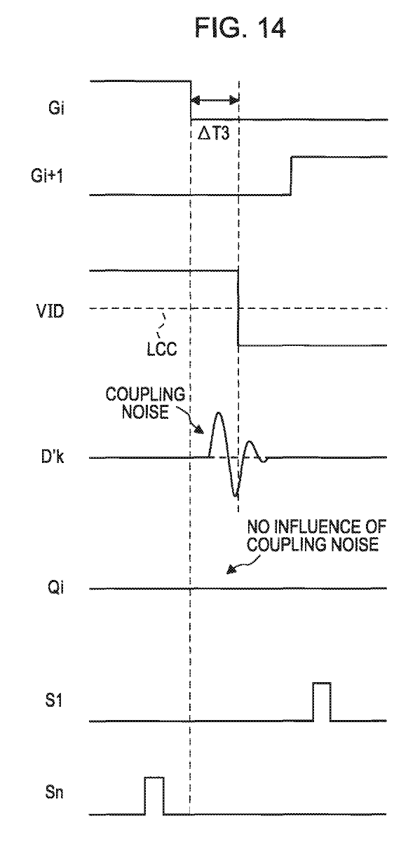

A liquid crystal device according to a second embodiment will be described with reference to FIGS. 12 to 14. FIG. 12 is a circuit diagram showing a circuit configuration of the scanning line driving circuit 104 used in the second embodiment. FIG. 13 is a timing chart showing timings at which scanning signals are supplied. FIG. 14 is a timing chart showing a timing at which a scanning signal falls in the second embodiment. In FIGS. 12 to 14, the same component parts as in the first embodiment described with reference to FIGS. 1 to 11 are referred to with the same reference numerals and the descriptions of those same component parts will not be repeated here.

The liquid crystal device according to the second embodiment is configured such that the timing at which the level of the waveform of a scanning signal Gi falls is advanced, using an enable signal, which will be described later, by a predetermined period with respect to the timing at which the polarity of an image signal VID is inverted.

Referring to FIG. 12, the scanning line driving circuit 104 includes a shift register 66 and m logic circuits 67.

The shift register 66 outputs transfer signals SRi (i=2, 3, . . . , and m) in accordance with a Y clock signal CLY and an inverted Y clock signal CLYinv whose phase difference has been corrected by the phase difference correction circuit 500. Unlike the liquid crystal device according to the first embodiment, the resistors 410 are not provided in the liquid crystal device according to the second embodiment. That is, the timings at which the levels of the waveforms of the Y clock signal CLY and the inverted Y clock signal CLYinv, which are input to the scanning line driving circuit 104, are the same as the timing at which the polarity of an image signal VID is inverted.

The m logic circuits 67 are provided so as to correspond to the m scanning lines 11a. Each of the logic circuits 67 outputs, as a scanning signal Gi, the logical product of a transfer signal SRi and an enable signal ENBY to the corresponding scanning line 11a.

The enable signal ENBY is generated by the timing control circuit 400, and is supplied to the scanning line driving circuit 104 through an enable signal line 92.

In the second embodiment, in particular, the timing control circuit 400 adjusts the timing at which the level of the waveform of the enable signal ENBY falls to be advanced by a predetermined period ΔT3 with respect to the timing at which the level of the waveform of the Y clock signal CLY or the inverted Y clock signal CLYinv falls. The predetermined period ΔT3 may be set in advance such that the level of the waveform of the enable signal ENBY falls before coupling noise is generated in the data line potential when the polarity of the image signal VID is inverted.

That is, as shown in FIG. 13, in the second embodiment, in particular, the pulse width of a scanning signal Gi is limited (that is, the fall timing of the scanning signal Gi is defined) by the enable signal ENBY. In addition, the fall timing of the scanning signal Gi is advanced by the predetermined period ΔT3 with respect to the timing at which the polarity of the image signal VID is inverted.

More specifically, as shown in FIG. 14, the timing at which the TFTs 30 that are electrically connected to the scanning line 11a to which the scanning signal Gi is supplied before the polarity of the image signal VID is inverted are turned off is advanced with respect to the timing at which generation of coupling noise in the data line potential D′k starts. Thus, the TFTs 30 that are electrically connected to the scanning line 11a to which the scanning signal Gi is supplied before the polarity of the image signal VID is inverted are switched from on to off in a state in which the data line potential D′k and the pixel potential Qi are at a desired potential (that is, the TFTs 30 are switched from on to off before the generation of the coupling noise generated in the data line potential D′k). Thus, the influence of the coupling noise generated in the data line potential D′k on the pixel potential Qi can be reduced or prevented. Accordingly, blurring or the like in image display or generation of a streak display effect can be reduced or prevented, resulting in achieving image quality with high accuracy.

In FIG. 14, it is desirable that the predetermined period ΔT3 is set to, for example, 200 to 300 nanoseconds. That is, it is desirable that the timing control circuit 400 sets the timing at which the enable signal ENBY falls such that the predetermined period ΔT3 is, for example, 200 to 300 nanoseconds. Accordingly, before coupling noise is generated in the data line potential D′k, the TFTs 30 that are electrically connected to the scanning line 11a to which the scanning signal Gi is supplied before the polarity of the image signal VID is inverted can be switched on to off in a state in which the data line potential D′k and the pixel potential Qi are at a desired potential.

In FIG. 14, the predetermined period ΔT3 can be set within a period of time from the timing at which the level of the waveform of the sampling signal Sn that is supplied immediately before the timing of the inversion of the polarity of the image signal VID to the timing at which the polarity of the image signal VID is inverted. That is, since the pixel potential Qi is at a desired potential after the sampling switch 71 to which the sampling signal Sn is supplied is turned off, the TFTs 30 that are electrically connected to the scanning line 11a to which the scanning signal Gi is supplied can be switched from on to off in a state in which the data line potential D′k and the pixel potential Qi are at the desired potential.

### Electronic Apparatus

A case where the above-described liquid crystal device, which is an electro-optical device, is used in various electronic apparatuses will be described.

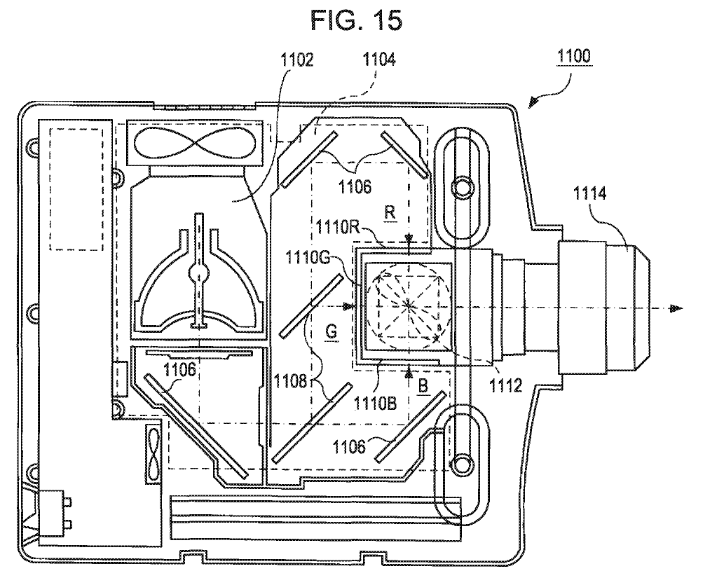

A projector using the liquid crystal device as a light valve will be described. FIG. 15 is a plan view showing an example of the configuration of a projector 1100. Referring to FIG. 15, a lamp unit 1102 including a white light source, such as a halogen lamp, is provided inside the projector 1100. Projection light emitted from the lamp unit 1102 is separated into three primary colors, a red (R) beam, a green (G) beam, and a blue (B) beam, by four mirrors 1106 and two dichroic mirrors 1108 contained in a light guide 1104, and the beams of the three primary colors are incident to liquid crystal panels 1110R, 1110G, and 1110B serving as light values for the corresponding colors.

The configuration of each of the liquid crystal panels 1110R, 1110G, and 1110B is similar to that of the above-described liquid crystal device. The liquid crystal panels 1110R, 1110G, and 1110B are driven in accordance with primary-color signals for corresponding R, G, and B colors supplied from an image signal processing circuit. Beams modulated by the liquid crystal panels 1110R, 1110G, and 1110B are incident to a dichroic prism 1112 from three directions. In the dichroic prism 1112, the red beam and the blue beam are refracted at 90 degrees, and the green beam goes straight. Thus, after the images of the respective colors are combined, a projector lens 1114 projects a color image on a screen or the like.

When attention is paid to display images formed by the liquid crystal panels 1110R, 1110G, and 1110B, a display image formed by the liquid crystal panel 1110G needs to be left-right inverted with respect to display images formed by the liquid crystal panels 1110R and 1110B.

Since beams corresponding to R, G, and B colors are incident through the dichroic mirror 1108 to the liquid crystal panels 1110R, 1110G, and 1110B, there is no need to provide a color filter.

In addition to the electronic apparatus described with reference to FIG. 15, a mobile personal computer, a cellular phone, a liquid crystal television set, a view-finder type or monitor direct-view type video tape recorder, a car navigation apparatus, a pager, an electronic notebook, an electronic calculator, a word processor, a workstation, a television telephone, a point-of-sale (POS) terminal, an apparatus provided with a touch panel, and the like may be adopted. Obviously, the invention is also applicable to any of such electrophoretic apparatuses.

The invention is applicable not only to the liquid crystal device according to each of the foregoing embodiments, but also to a reflective liquid crystal device (liquid crystal on silicon (LCOS)) in which elements are formed on a silicon substrate, a plasma display panel (PDP), a field emission display (FED), a surface-conduction electron-emitter display (SED), an organic electroluminescence (EL) display, a digital micromirror device (DMD), an electrophoretic apparatus, and the like.

The invention is not limited to the foregoing embodiments, and various modifications may be made to the invention within the scope of the claims and without departing from the spirit of the invention. Electro-optical devices involving such modifications, methods for driving such electro-optical devices involving such modifications, and electronic apparatuses including such electro-optical devices involving such modifications also fall within the technical concept of the invention.

The entire disclosure of Japanese Patent Application No. 2006-109464, filed Apr. 12, 2006 is expressly incorporated by reference herein.

What is claimed is:

1. An electro-optical device comprising:
a substrate;
a plurality of pixel electrodes that are disposed in a pixel area on the substrate;
a plurality of scanning lines and a plurality of data lines that are disposed on the substrate so as to intersect each other in the pixel area;
an image signal line that is disposed on the substrate, an image signal being supplied to the image signal line, the polarity of the image signal being inverted, every horizontal scanning period, between a positive polarity in which the potential of the image signal is higher than a predetermined potential and a negative polarity in which the potential of the image signal is lower than the predetermined potential;
a sampling circuit that is disposed on the substrate and that includes a plurality of sampling switches each supplying one of a plurality of sampled image signals to a corresponding one of the data lines in accordance with a corresponding one of a plurality of sampling signals;
a data line driving circuit that is disposed on the substrate and that outputs the sampling signals at timings at which the sampled image signals are to be supplied to the corresponding data lines;
a plurality of switching elements that are disposed on the substrate so as to be each electrically connected to a corresponding one of the scanning lines and a corresponding one of the data lines and that perform switching control on the sampled image signals to be supplied from the corresponding data lines to the pixel electrodes corresponding thereto; and
a scanning line driving circuit that is disposed on the substrate and that supplies to each of the plurality of scanning lines a scanning signal for switching the state of the corresponding switching element from on to off at a timing that is shifted by a predetermined period of time with respect to a timing at which the polarity of the image signal is inverted.

2. The electro-optical device according to claim 1,
wherein each of the plurality of switching elements is turned off at a fall timing at which the level of the waveform of the scanning signal falls, and
wherein the fall timing is advanced with respect to the timing at which the polarity of the image signal is inverted.

3. The electro-optical device according to claim 1,
wherein each of the plurality of switching elements is turned off at a fall timing at which the level of the waveform of the scanning signal falls, and
wherein the fall timing is delayed with respect to the timing at which the polarity of the image signal is inverted.

4. The electro-optical device according to claim 2, further comprising an enable signal line that supplies to the scanning line driving circuit an enable signal in which a timing at which the level of the waveform of the enable signal falls is advanced by the predetermined period of time with respect to the timing at which the polarity of the image signal is inverted, wherein
the scanning line driving circuit includes a shift register that sequentially outputs transfer signals from a plurality of stages in accordance with a clock signal having a predetermined cycle and a plurality of logic circuits that perform shaping of pulses of the sequentially output transfer signals using the enable signal.

5. The electro-optical device according to claim 3, further comprising:
a clock signal line to which a clock signal having a predetermined cycle that defines the fall timing is supplied; and
a resistor that is electrically connected between the clock signal line and the scanning line driving circuit.

6. A method for driving an electro-optical device including a substrate; a plurality of pixel electrodes that are disposed in a pixel area on the substrate; a plurality of scanning lines and a plurality of data lines that are disposed on the substrate so as to intersect each other in the pixel area; an image signal line that is disposed on the substrate, an image signal being supplied to the image signal line; a sampling circuit that is disposed on the substrate and that includes a plurality of sampling switches each supplying one of a plurality of sampled image signals to a corresponding one of the data lines in accordance with a corresponding one of a plurality of sampling signals; a data line driving circuit that is disposed on the substrate and that outputs the sampling signals to the corresponding data lines; a plurality of switching elements that are disposed on the substrate so as to be each electrically connected to a corresponding one of the scanning lines and a corresponding one of the data lines and that perform switching control on the sampled image signals to be supplied from the corresponding data lines to the pixel electrodes corresponding thereto; and a scanning line driving circuit that is disposed on the substrate and that outputs a scanning signal to each of the plurality of scanning lines, the method comprising:
supplying the image signal to the image signal line such that the polarity of the image signal is inverted, every horizontal scanning period, between a positive polarity in which the potential of the image signal is higher than a predetermined potential and a negative polarity in which the potential of the image signal is lower than the predetermined potential; and
supplying the scanning signal to each of the plurality of switching elements via the corresponding scanning line such that the switching element is turned on at a timing at which the corresponding sampled image signal is to be supplied to the corresponding pixel electrode and such that the switching element in the on-state is turned off at a timing that is shifted by a predetermined period of time with respect to a timing at which the polarity of the image signal is inverted.

7. An electronic apparatus comprising the electro-optical device according to claim 1.
